(19) United States
(12) Patent Application Publication
(10) Pub. No.: US 2003/0233227 A1
(43) Pub. Date: Dec. 18, 2003

(54) Method for estimating mixing parameters and separating multiple sources from signal mixtures

(76) Inventors: Scott Thurston Rickard JR., Princeton, NJ (US); Radu Victor Balan, West Windsor, NJ (US)

Correspondence Address: Siemens Corporation, Intellectual Property Department, 170 Wood Avenue South, Iselin, NJ, 08830, US

(21) Appl. No.: 10/459,939

(22) Filed: Jun. 12, 2003

Related U.S. Application Data
(60) Provisional application No. 60/394,318, filed on Jun. 13, 2002.

(51) Int. Cl. G10L 11/00

(52) U.S. Cl. 704/200

(57) ABSTRACT

A method and apparatus for separating multiple sources from a mixed source signal includes receiving a plurality of mixed source signals, estimating mixing parameters of the received mixed source signals using at least one of a differential Degenerate Unmixing Estimation Technique (“DUET”) and a tiled DUET, and separating multiple sources from the mixed source signals in response to the estimated mixing parameters using a Blind Source Separation (“BSS”) technique.

### CROSS-REFERENCE TO RELATED APPLICATIONS

This application claims the benefit of U.S. Provisional Application Serial No. 60/394,318 (Attorney Docket No. 2002P09431US), filed Jun. 13, 2002 and entitled “Method for Estimating Mixing Parameters and Separating Multiple Sources from Signal Mixtures”, which is incorporated herein by reference in its entirety.

### BACKGROUND

The present disclosure relates to estimating multiple source signals from acoustic or electromagnetic mixtures thereof, and more particularly, to estimating mixing parameters and separating multiple sources from the mixtures. Blind source separation (“BSS”) includes a class of methods typically used to estimate individual original signals from mixtures of the signals.

One area where BSS methods are useful is in the electromagnetic domain, such as, for example, in communications systems where nodes or receiving antennas typically receive a mixture of delayed and attenuated signals from signal sources. Another area where these methods are useful is in the acoustic domain where it is often desirable to separate a single voice or other signal of interest from the background or other voices received, such as by microphones in a telephone or hearing aid. Other exemplary areas where BSS may be usefully applied include surface acoustic wave processing, radar signal processing and general signal processing.

### SUMMARY

These and other drawbacks and disadvantages of the prior art are addressed by an apparatus and method for estimating mixing parameters and separating multiple sources from signal mixtures.

A method and apparatus for separating multiple sources from a mixed source signal includes receiving a plurality of mixed source signals, estimating mixing parameters of the received mixed source signals using at least one of a differential Degenerate Unmixing Estimation Technique (“DUET”) and a tiled DUET, and separating multiple sources from the mixed source signals in response to the estimated mixing parameters using a Blind Source Separation (“BSS”) technique.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches an apparatus and method for estimating mixing parameters and separating multiple sources from signal mixtures in accordance with the following exemplary figures, in which:

FIG. 1 shows a schematic diagram of a microphone array with multiple signal sources; and

FIG. 2 shows graphical diagrams of blind source separation (“BSS”) results for a microphone array with multiple signal sources in accordance with illustrative embodiments of the present disclosure.

### DETAILED DESCRIPTION OF PREFERRED EMBODIMENTS

The present disclosure presents an apparatus and method for estimating mixing parameters and separating multiple sources from signal mixtures in accordance with blind source separation (“BSS”) techniques. Potential applications include adaptive signal processing schemes for hearing aids, car kits, mobile communications, voice controlled devices, and the like.

Mixing parameters of the signals of interest are determined from a pair of acoustic or electromagnetic mixtures. The signals are extracted from the mixtures via a technique that looks at the phase difference between adjacent time frequency ratios of the mixtures, and/or tiles Degenerate Unmixing Estimation Technique (“DUET”) amplitude-delay power histograms created by delaying one mixture relative to the other. For example, the signals of interest could be voices in a room, in which case this method identifies the spatial signature of each voice and extracts the individual voice signals from the mixtures.

Two embodiments of the present method are described for estimating mixing parameters and blindly separating an arbitrary number of sources using as few as two mixtures. The method of the present disclosure applies when sources are disjoint or W-disjoint orthogonal, such as when the supports of the Fourier transform or windowed Fourier transform of any two signals in the mixture are disjoint sets. For anechoic mixtures of attenuated and delayed sources, the method provides estimation of the mixing parameters by clustering ratios of the time frequency representations of the mixtures.

The method of the present disclosure also applies when sources are W-disjoint orthogonal only in an approximate sense. That is, the time-frequency representations of the original sources do not have to be disjoint, but rather, a majority of the energy of each source should be contained in time-frequency points where the source is much louder than the interfering sources. This property is true for many signal classes, including, for example, speech, music, biological signals, and many types of wireless communication signals.

The estimates of the mixing parameters are then used to partition the time frequency representation of one mixture to recover the original source signals. The technique is valid even in the case where the number of sources is larger than the number of mixtures.

Prior DUET implementations were generally limited to being able to estimate the mixing parameters and separate sources that arrived within an intra mixture delay of less than ½ fₘ, where fm was the highest frequency of interest in the source. Thus, the prior DUET was only applicable when the sensors were separated by at most c/2 fₘ meters, where c is the speed of the signals. For example, with voice mixtures where the highest frequency of interest is 4000 Hz and the speed of sound is 340 m/s, the microphones for prior DUET techniques generally had to be separated by less than about 4.25 cm in order for DUET to be able to localize and separate the source. In some applications, microphones cannot be placed so closely together.

The presently disclosed method extends the functionality over prior DUET techniques to allow for arbitrary microphone spacing. This disclosure presents two exemplary embodiments on the method for extending DUET for arbitrary sensor spacing.

The first embodiment involves analyzing the phase difference between frequency adjacent time frequency ratios to estimate the delay parameter. This embodiment increases the maximum possible separation between sensors from ½ fₘ to ½ Δ_{f} where Δ_{f} is the frequency spacing between adjacent frequency bins in the time frequency representation. Since Δ_{f} can be chosen, this effectively removes the sensor spacing constraint.

The second embodiment involves iteratively delaying one mixture against the second and constructing an amplitude-delay power histogram for each delay. When the delaying of one mixture moves the intra-sensor delay of a source to less than ½ fₘ, the delay estimates will align and a peak will emerge. When the intra-sensor delay of a source is larger than ½ fₘ, the delay estimates will spread and no dominant peak will be visible. The amplitude-delay histograms are then tiled to produce an amplitude-delay histogram that covers a large range of possible delays, and the true mixing parameter peaks become generally dominant in this larger histogram.

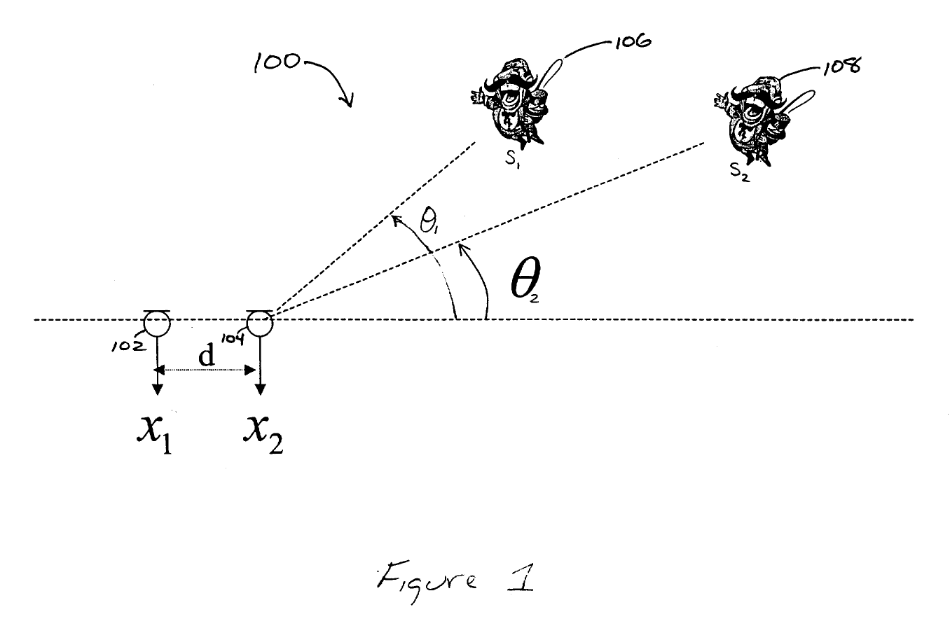

As shown in FIG. 1, a 2-Microphone Array with incident directions of arrival (“DOA”) is indicated generally by the reference numeral 100. The exemplary array includes a first microphone 102 and a second microphone 104 disposed a fixed distance d from the first microphone. A first signal source 106 is disposed at an angle θ₁ relative to the line of the microphones.

The angleθ₁ represents the DOA of the first signal source. A second signal source 108 is disposed at an angle θ₂ relative to the line of the microphones.

The mixing model and assumptions for a standard DUET, up to the point of the creation of the histogram, are described below. Also described is the alteration in delay estimation, which is comprised by the first embodiment of the presently disclosed method. In addition, the second embodiment of the presently disclosed method is described, and the delay estimator performance is compared.

The mixing model and assumptions are considered for an anechoic mixing model defined by the following equations:

$$\begin{matrix}{x}_{2} ( t ) = {\sum }_{j = 1}^{N} {s}_{j} ( t ) + {n}_{1} ( t ) , \\ {x}_{2} ( t ) = {\sum }_{j = 1}^{N} {a}_{j} {s}_{j} ( t - {δ}_{j} ) + {n}_{2} ( t ) ,\end{matrix}$$

where x₁(t) and x₂(t) are the mixtures, sⱼ(t) are sources with relative amplitude and delay mixing parameters aⱼ and δⱼ, and n₁(t) and n₂(t) are noise. In the frequency domain, mixing becomes:

$$[ \begin{matrix}{X}_{1} ( w ) \\ {X}_{2} ( w )\end{matrix} ] = [ \begin{matrix}1 & ⋯ & 1 \\ {a}_{1} {ⅇ}^{- ⅈ w {δ}_{1}} & ⋯ & {a}_{N} {ⅇ}^{- ⅈ w {δ}_{N}}\end{matrix} ] [ \begin{matrix}{S}_{1} ( w ) \\ ⋮ \\ {S}_{N} ( w )\end{matrix} ] + [ \begin{matrix}{N}_{1} ( w ) \\ {N}_{2} ( w )\end{matrix} ] .$$

assuming that the above frequency domain mixing is true in a time-frequency sense:

$$[ \begin{matrix}{X}_{1} ( w , τ ) \\ {X}_{2} ( w , τ )\end{matrix} ] = [ \begin{matrix}1 & ⋯ & 1 \\ {a}_{1} {ⅇ}^{- ⅈ w {δ}_{1}} & ⋯ & {a}_{N} {ⅇ}^{- ⅈ w {δ}_{N}}\end{matrix} ] [ \begin{matrix}{S}_{1} ( w , τ ) \\ ⋮ \\ {S}_{N} ( w , τ )\end{matrix} ] + [ \begin{matrix}{N}_{1} ( w , τ ) \\ {N}_{2} ( w , τ )\end{matrix} ] ,$$

where the time-frequency representation of a signal is formed via:

$${S}_{i}^{W} ( w , τ ) = {F}^{W} ( {s}_{i} ( \cdot ) ) ( w , τ ) = {\int }_{- ∞}^{∞} W ( t - τ ) {s}_{i} ( t ) {ⅇ}^{- τ wt} ⅆ t .$$

which is commonly referred to as the windowed Fourier transform of sᵢ(t). Let us also assume that our sources satisfy W—disjoint orthogonality, defined as:

$${S}_{i}^{W} ( w , τ ) {S}_{i}^{W} ( w , τ ) = 0 , ∀ i \neq j , ∀ w , τ .$$

Mixing under disjoint orthogonality can be expressed as:

$$[ \begin{matrix}{X}_{1} ( w , τ ) \\ {X}_{2} ( w , τ )\end{matrix} ] = [ \begin{matrix}1 \\ {a}_{1} {ⅇ}^{- ⅈ w {δ}_{1}}\end{matrix} ] {S}_{i} ( w , τ ) + [ \begin{matrix}{N}_{1} ( w , τ ) \\ {N}_{2} ( w , τ )\end{matrix} ] , for some i .$$

Define R(w,τ), the time-frequency mixture ratio, as:

$$R ( w , τ ) = \frac{{X}_{1}^{W} ( w , τ ) \overline{{X}_{2}^{W} ( w , τ )}}{{‖ {X}_{2}^{W} ( w , τ ) ‖}^{2}} .$$

Note that under our assumptions, R(w,τ)=aᵢe^{τwδ}^{ᵢ} for some index i. Thus, for each (w,τ) pair, if |wδᵢ|<π, we can extract an (a,δ) estimate using:

(â(w,τ), \hat{δ}(w,τ))=(|R(w,τ)|,Im(log(R(w,τ))/w)).

We then construct a 2D histogram H via,

$$H ( m , n ) = {{\sum }_{w , τ such that}}_{m = \hat{A} ( w , τ ) , n = \hat{Δ} ( w , τ )} \vert {X}_{1}^{W} ( w , τ ) {X}_{2}^{W} ( w , τ ) \vert ,$$

where,

Â(w,τ)=[aₙᵤₘ(â(w,τ)−aₘᵢₙ)/(aₘₐₓ−aₘᵢₙ)].

\hat{Δ}(w,τ)=[δₙᵤₘ(\hat{δ}(w,τ)−δₘᵢₙ)/(δₘₐₓ−δₘᵢₙ)].

where aₘᵢₙ,aₘₐₓ, δₘᵢₙ,δₘₐₓ, are the maximum and minimum allowable amplitude and delay parameters, and aₙᵤₘ,δₙᵤₘ are the number of histogram bins to use along each axis. The histogram is the key structure used for localization and separation.

In the first or differential embodiment of the presently disclosed method, the additional assuption is made that:

$$\vert {S}_{i}^{W} ( w , τ ) \vert \approx \vert {S}_{i}^{W} ( w + Δ w , τ ) \vert , ∀ i , ∀ w , τ .$$

That is, the power in the time frequency domain of each source is a smooth function of frequency. Under this and previous assumptions from above, we have:

$$[ \begin{matrix}{X}_{1} ( w , τ ) \\ {X}_{2} ( w , τ )\end{matrix} ] = [ \begin{matrix}1 \\ {a}_{i} {ⅇ}^{- ⅈ w {δ}_{i}}\end{matrix} ] S ( w , τ ) + [ \begin{matrix}{N}_{1} ( w , τ ) \\ {N}_{2} ( w , τ )\end{matrix} ] , for some i .$$

and now, in addition, we have,

$$[ \begin{matrix}{X}_{1} ( w + Δ w , τ ) \\ {X}_{2} ( w + Δ w , τ )\end{matrix} ] = [ \begin{matrix}1 \\ {a}_{i} {ⅇ}^{- ⅈ ( w + Δ w ) {δ}_{i}}\end{matrix} ] S ( w + Δ w , τ ) + [ \begin{matrix}{N}_{1} ( w + Δ w , τ ) \\ {N}_{2} ( w + Δ w , τ )\end{matrix} ] , for some i .$$

where the source index is the same. Thus

\hat{R}(w,τ)=\overline{R(w,τ)}R(w+Δw,τ)=(aᵢe^{-τwδ}_{ⁱ})(aᵢe^{τ(w+Δw)δ}_{ⁱ})=aᵢ²e^{τΔwδ}_{ⁱ},

and the |wδ|<π constraint has been loosened to |Δwβ|<π. We can estimate the delay via,

\hat{δ}(w,τ)=Im(log(\hat{R}(w,τ))/Δw).

Note that Δw is a parameter that can be made arbitrarily small by oversampling along the frequency axis. As the estimation of the delay from \hat{R}(w,τ) is essentially the estimation of the derivative of a noisy function, results can be improved by averaging delay estimates over a local time-frequency region,

$$\hat{δ} ( w , τ ) = \frac{1}{( 2 I + 1 ) ( 2 J + 1 )} {\sum }_{i ∈ \{ - I , … , I \} , j ∈ \{ - J , … , J \}} Im ( log ( \hat{R} ( w + i Δ w , τ + j Δ τ ) ) / ( w + i Δ w ) ) .$$

Demixing is accomplished by using the histogram tile that contains the source peak to be separated. As the intereference from other sources will tend to be separated at zero delay, it is prefered to use a histogram tile where the peak is not centered at zero for separation.

The second or tiling embodiment of the presently disclosed method further constructs a number K of amplitude-delay histograms by iteratively delaying one mixture against the other. The histograms are appropriately overlapped corresponding to the delays used and summed to form one large histogram with the range of delays K times the amount of the overlap larger than the size of the individual histogram.

Let b be the number of time bins that the histograms overlap and let Hₖ be the histogram constructed for the mixtures where the second mixture has been shifted in time by

−(δₘₐₓ−δₘᵢₙ)/δₙᵤₘ.

Then, the large histogram H can be defined as:

$$H ( m , n ) = {\sum }_{k = - K}^{K} Hk ( m , n - k )$$

We can express the delay estimate as,

$$\hat{δ} = δ - \frac{π}{w} ⌊ \frac{w δ }{π} ⌋ ,$$

where ^{└x┘} denotes rounding towards zero. Thus the peak for the source in the histogram corresponding to the mixtures being aligned such that the relative delay for the source is small and will be well localized at the correct value. This case corresponds to the case when ^{|wδ|<π.} For histograms constructed for cases when ^{|wδ|>π,} it is clear that the estimate will be incorrect and that the estimates for adjacent overlapped histograms will not align. It can be shown that the range of the incorrect estimates is ^{(-δ,δ/3)}, and for large ^{|wδ|} the estimates are close to zero. Thus, the peaks that emerge in the overall histogram will correspond to the true delays. Demixing can be accomplished using the standard DUET demixing as known in the art.

In the figures, one-dimensional histogram results are presented that are summed over the amplitude direction in order to focus on the delay estimation issue:

$$H ( n ) = {\sum }_{m}^{} H ( m , n )$$

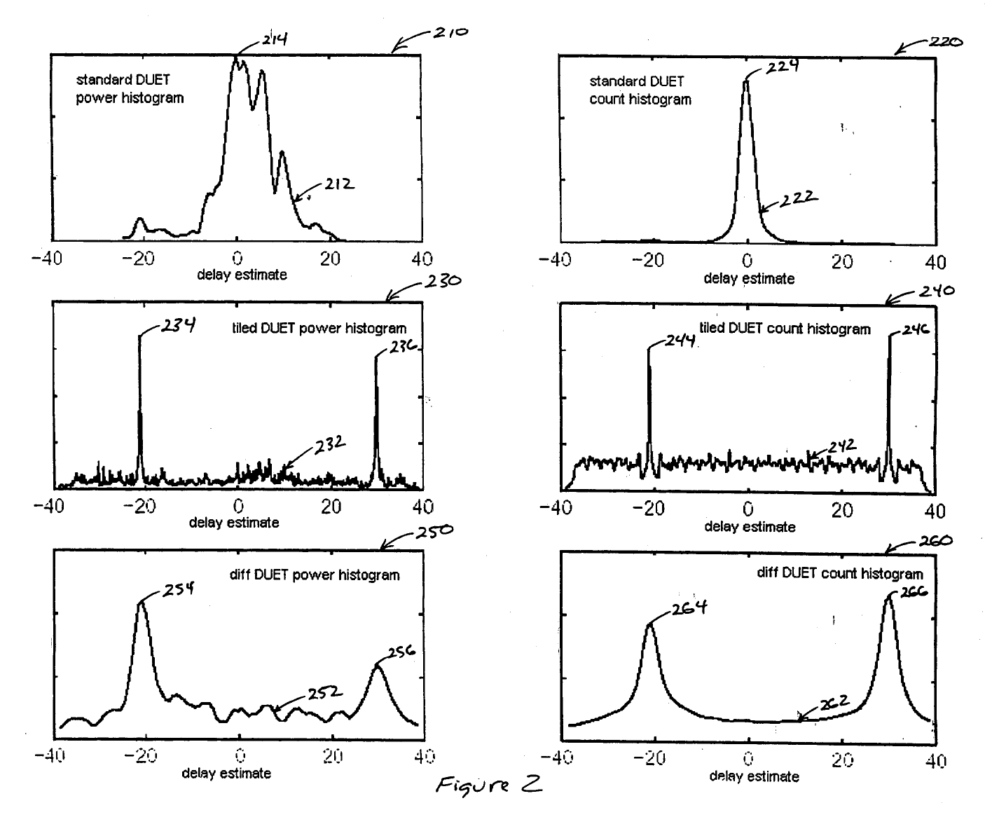

Turning to FIG. 2, a standard DUET power histogram is indicated generally by the reference numeral 210, a standard DUET count histogram is indicated generally by the reference numeral 220, a tiled DUET power histogram is indicated generally by the reference numeral 230, a tiled DUET count histogram is indicated generally by the reference numeral 240, a differential DUET power histogram is indicated generally by the reference numeral 250, and a differential DUET count histogram is indicated generally by the reference numeral 260.

The histograms of FIG. 2 show delay estimate histograms for a two source mixing example. The histograms 210, 230 and 250 are power histograms, while the histograms 220, 240 and 260 are standard count histograms. The histograms 210 and 220 were constructed using standard DUET. The histograms 230 and 240 using were constructed using tiled DUET of the second embodiment. The histograms 250 and 260 were constructed using differential DUET of the first embodiment.

In the histogram 210, the standard DUET power trace is indicated by the reference numeral 212, and includes a single peak 214. A single peak fails to separate the two original sources. In the histogram 220, the standard DUET count trace is indicated by the reference numeral 222, and includes a single peak 224. In the histogram 230, the tiled DUET power trace is indicated by the reference numeral 232, and includes a peak 234 and a peak 236. The two peaks successfully separate the two original sources. In the histogram 240, the tiled DUET count trace is indicated by the reference numeral 242, and includes a peak 244 and a peak 246. In the histogram 250, the differential DUET power trace is indicated by the reference numeral 252, and includes a peak 254 and a peak 256. In the histogram 260, the differential DUET power trace is indicated by the reference numeral 262, and includes a peak 264 and a peak 266.

In each case, the two sources were delayed by −21 and 30 samples, respectively, as indicated on the horizontal axes of the histograms. For the vertical axes, the vertical axis represent sum power for the power histograms 210, 230 and 250. That is, these histograms are weighted histograms where the value in each bin is a function of the power of all the time-frequency points that yield estimates falling in range of the bin. The vertical axes of the count histograms 220, 240 and 260 represent the count. That is, these histograms are standard histograms that count the number of time-frequency points that yield delay estimates in each bin, preferably only counting time-frequency points with power above a given threshold. Thus, these histogram test results demonstrate that the two exemplary embodiments of the presently disclosed method correctly estimate the delays in cases where standard DUET fails.

These and other features and advantages of the present disclosure may be readily ascertained by one of ordinary skill in the pertinent art based on the teachings herein. It is to be understood that the teachings of the present disclosure may be implemented in various forms of hardware, software, firmware, special purpose processors, or combinations thereof.

Most preferably, the teachings of the present disclosure are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. All such changes and modifications are intended to be included within the scope of the present disclosure as set forth in the appended claims.

What is claimed is:

1. An apparatus for separating multiple sources from a mixed source signal, the apparatus comprising:
a plurality of transducers for transducing the mixed source signal;
estimation means responsive to the plurality of transducers for estimating mixing parameters of the mixed source signal; and
separation means responsive to the estimation means for separating multiple sources from the mixed source signal.

2. An apparatus as defined in claim 1 wherein the plurality of transducers comprises a plurality of microphones.

3. An apparatus as defined in claim 1 wherein the estimation means comprises a Degenerate Unmixing Estimation Technique (“DUET”).

4. An apparatus as defined in claim 3 wherein the estimation means further comprises a differential DUET.

5. An apparatus as defined in claim 3 wherein the estimation means further comprises a tiled DUET.

6. An apparatus as defined in claim 1 wherein the separation means comprises a Blind Source Separation (“BSS”) technique.

7. A method for separating multiple sources from a mixed source signal, the method comprising:
receiving a plurality of mixed source signals;
estimating mixing parameters of the received mixed source signals; and
separating multiple sources from the mixed source signals in response to the estimated mixing parameters.

8. A method as defined in claim 7, further comprising transducing the received plurality of mixed source signals.

9. A method as defined in claim 7 wherein said transducing comprises:
receiving a plurality of acoustic signals; and
transducing the acoustic signals into electronic signals.

10. A method as defined in claim 7 wherein estimating comprises implementing a Degenerate Unmixing Estimation Technique (“DUET”).

11. A method as defined in claim 10 wherein estimating further comprises implementing a differential DUET.

12. A method as defined in claim 10 wherein estimating further comprises implementing a tiled DUET.

13. A method as defined in claim 7 wherein separating comprises implementing a Blind Source Separation (“BSS”) technique.

14. A program storage device readable by machine, tangibly embodying a program of instructions executable by the machine to perform program steps for separating multiple sources from a mixed source signal, the program steps comprising:
receiving a plurality of mixed source signals;
estimating mixing parameters of the received mixed source signals; and
separating multiple sources from the mixed source signals in response to the estimated mixing parameters.

15. A program storage device as defined in claim 14, the program steps further comprising transducing the received plurality of mixed source signals.

16. A program storage device as defined in claim 14 wherein the program step for transducing comprises program sub-steps for:
receiving a plurality of acoustic signals; and
transducing the acoustic signals into electronic signals.

17. A program storage device as defined in claim 14 wherein the program step for estimating comprises program sub-steps for implementing a Degenerate Unmixing Estimation Technique (“DUET”).

18. A program storage device as defined in claim 17 wherein the program step for estimating further comprises program sub-steps for implementing a differential DUET.

19. A program storage device as defined in claim 17 wherein the program step for estimating further comprises program sub-steps for implementing a tiled DUET.

20. A program storage device as defined in claim 14 wherein the program step for separating comprises implementing a Blind Source Separation (“BSS”) technique.
